(19) United States
(12) Patent Application Publication
(10) Pub. No.: US 2011/0032974 A1
(43) Pub. Date: Feb. 10, 2011

(54) CARRIER FREQUENCY SYNCHRONIZATION DETECTION CIRCUIT AND CORRELATION CALCULATOR

(75) Inventor: Shingo Karino, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/903,897

(22) Filed: Oct. 13, 2010

Related U.S. Application Data
(63) Continuation of application No. PCT/JP2010/003783, filed on Jun. 7, 2010.

(30) Foreign Application Priority Data
Jul. 3, 2009 (JP) 2009-158495

(51) Int. Cl. H04B 1/707

(52) U.S. Cl. 375/142; 375/E01.002

(57) ABSTRACT

A correlation calculator and carrier frequency synchronization detection circuit are provided that enable a code phase, carrier frequency, and carrier frequency phase match to be detected even if a carrier frequency is greatly displaced. A correlation value calculation section (130) has n storage elements (501 through 507) that store a spread code, n-integral-multiple first delay elements (401 through 414) that perform sequential shifting by delaying an I component baseband signal by a fixed time interval, and n-integral-multiple first multipliers (701 through 714) that respectively perform multiplication between sequentially shifted I component baseband signals and the storage elements (501 through 507). The same kind of configuration as in the case of an above I component baseband signal is also provided for a Q component baseband signal.

### CROSS REFERENCE TO RELATED APPLICATIONS

The disclosures of Japanese Patent Application No. 2009-158495, filed on Jul. 3, 2009 including the specification, drawings and abstract are incorporated herein by reference in its entirety.

### TECHNICAL FIELD

The present invention relates to a carrier frequency synchronization detection circuit and correlation calculator.

### BACKGROUND ART

In recent years, receivers of an SPS (Satellite Positioning System) typified by GPS (Global Positioning System) have become widely used as position sensors in car navigation systems, marine navigation apparatuses, and aircraft navigation apparatuses.

in a GPS system, a receiving-side GPS receiver measures the position of the receiver itself based on spread spectrum signals transmitted from a plurality of transmitting-side positioning satellites (for example, NAVSTAR satellites or GLONASS satellites). The plurality of transmitting-side positioning satellites perform spreading processing (scrambling) of signals transmitted to the receiving side in a spread code sequence. Then the plurality of positioning satellites modulate spreading-processed signals (hereinafter referred to as spread spectrum signals) using an identical carrier frequency, and transmit them to the receiving-side GPS receiver.

The receiving-side GPS receiver receives a spread spectrum signal transmitted from a positioning satellite. Then the GPS receiver performs frequency demodulation of the carrier frequency to a baseband band by means of mixing, and performs despreading processing of the received spread spectrum signal in a spread code sequence generated by the GPS receiver, and extracts the original signal.

In a spread spectrum signal communication system, despreading cannot be performed on the receiving side unless spread code sequence phase synchronization is established between a transmitting-side positioning satellite and a GPS receiver. However, since a positioning satellite is moving at high speed, a carrier frequency fluctuates by several tens of kHz due to a Doppler effect. Consequently, a GPS receiver performs frequency error detection control in order to synchronize with a fluctuating carrier frequency (see Patent Literature 1, for example).

FIG. 1 is a block diagram showing a configuration of a receiver that performs frequency error detection control described in Patent Literature 1. In this spread spectrum communication system, a 1-symbol signal is described as being spread by means of an n-chip spread code.

As shown in FIG. 1, receiver 10 has radio section 11, timing detection apparatus 14 composed of despreader 12 and peak detection section 13, channel estimation apparatus 17 composed of despreader 15 and rotation correction section 16, demodulation section 18, AFC (Automatic Frequency Control) control circuit 19, and TCXO (Temperature Compensated Xtal Oscillator) 20.

Radio section 11 converts a received high-frequency signal to digital signal I (in-phase) component and Q (quadrature) component baseband signals 21 and 22 by performing quadrature detection and A/D conversion based on a reference frequency signal generated by TCXO 20.

TCXO 20 outputs a signal whose frequency has been controlled by AFC control circuit 19 as a reference frequency signal.

Despreader 12 performs despreading by multiplying I and Q component baseband signals 21 and 22 from radio section 11 by a spread code.

Peak detection section 13 detects spreading timing by detecting timing at which a correlation value becomes a peak value at the time of despreading by despreader 12.

Despreader 15 obtains a complex symbol from I and Q component symbols by despreading I and Q component baseband signals 21 and 22 from radio section 11 using spreading timing obtained by peak detection section 13.

FIG. 2 is a drawing showing a circuit configuration of above despreaders 12 and 15.

Despreaders 12 and 15 are despreaders for performing despreading of a complex baseband signal composed of component and Q component baseband signals spread by a spread code of n chips per symbol. Despreaders 12 and 15 employ the same configuration, and therefore despreader 12 will be described here as representative of the two.

As shown in FIG. 2, despreader 12 comprises first correlator 30, second correlator 40, m phase rotators 50-1 through 50-m, first adder 61, and second adder 62.

First correlator 30 has at least (n−1)-integral-multiple first delay elements 31-1, . . . , 31-OSR (n−1) that perform sequential shifting by delaying an I component baseband signal by a fixed time interval, and n first multipliers 32-1, . . . , 32-n that respectively perform multiplication between I component baseband signals sequentially shifted by the first delay elements and a spread code. Also, first correlator 30 has m (=n/k) first adders 33-1, . . . , 33-m that perform integration of outputs from k first multipliers among the n first multipliers and output an I component intermediate signal.

Second correlator 40 has second delay elements 41-1, . . . , 41-OSR (n−1) equal in number to number of chips per symbol n that perform sequential shifting by delaying a Q component baseband signal by a fixed time interval, and n second multipliers 42-1, 42-n that respectively perform multiplication between I component baseband signals sequentially shifted by the second delay elements and a spread code. Also, second correlator 40 has in second adders 43-1, . . . , 43-m that perform integration of outputs from k second multipliers among the n second multipliers and output a Q component intermediate signal.

Also, in phase rotators 50-1 through 50-m perform phase correction by rotating a phase on a complex plane in m phase rotation angle steps with m pairs of complex intermediate signals comprising in I component intermediate signals generated by the first correlators and m Q component intermediate signals generated by the second correlators displaced by reference rotation angle δ at a time per pair of complex intermediate signals.

First adder 61 calculates an I component correlation value by performing integration of the I components of in complex intermediate signals after rotation correction has been performed by the phase rotators.

Second adder 62 calculates a Q component correlation value by performing integration of the Q components of m complex intermediate signals after rotation correction has been performed by the phase rotators.

### Citation List

### Patent Literature

PTL 1: Unexamined Japanese Patent Publication No. 2001-069040

### SUMMARY OF INVENTION

### Technical Problem

However, with this kind of conventional frequency error detection control, error can only be corrected within a specific narrow range in which distribution of intermediate values of correlation values input to the phase rotators of a despreader is almost the same. For example, with a conventional carrier frequency synchronization detection circuit, frequency error cannot be corrected if a carrier frequency is greatly displaced due to a Doppler effect when a spread spectrum signal transmitted from a satellite is received by a GPS receiver.

It is an object of the present invention to provide a carrier frequency synchronization detection circuit and correlation calculator that enable a code phase, carrier frequency, and carrier frequency phase match to be detected even if a carrier frequency is greatly displaced.

### Solution to Problem

A carrier frequency synchronization detection circuit of the present invention employs a configuration having: a code generation section that generates a spread code for performing despreading processing in synchronization with a received signal on which spreading processing has been executed; a mixing section that removes a carrier frequency component from a received signal; a correlation value calculation section that calculates a correlation value between a received signal from which a carrier frequency component has been removed by the mixing section and a spread code generated by the code generation section and a plurality of correlation intermediate values of a predetermined correlation length; a correlation value averaging section that averages correlation values output from the correlation value calculation section, on a regular basis, in a plurality of periods; a maximum sorting section that selects a maximum correlation value from among averaged correlation values; a code phase selection section that determines spread code sequence generation timing based on a correlation value selected by the maximum sorting section; a correlation intermediate value monitoring section that outputs a carrier frequency correction value and carrier phase correction value from a correlation intermediate value output from the correlation value calculation section; and a carrier frequency generation section that outputs a carrier frequency to the mixing section based on the carrier frequency correction value and carrier phase correction value output from the correlation intermediate value monitoring section.

A correlation calculator of the present invention is a correlation calculator for performing correlation of a spread code with a complex baseband signal composed of in-phase component and quadrature component baseband signals spread by a spread code of n chips (where n is an arbitrary natural number of 2 or above) per symbol, and employs a configuration having: n storage elements that store a spread code; n-integral-multiple first delay elements that perform sequential shifting by delaying an in-phase component baseband signal by a fixed time interval, and n-integral-multiple first multipliers that respectively perform multiplication between in-phase component baseband signals sequentially shifted by first delay elements and the storage elements; and n-integral-multiple second delay elements that perform sequential shifting by delaying a quadrature component baseband signal by a fixed time interval, and n-integral-multiple second multipliers that respectively perform multiplication between quadrature component baseband signals sequentially shifted by second delay elements and the storage elements; wherein a result of performing integration of outputs from the first through (1×k)′th first multipliers among the n-integral-multiple first multipliers is taken as a correlation first in-phase intermediate value, a result of performing integration of outputs from the first through (2×k)′th first multipliers is taken as a correlation second in-phase intermediate value, and output as correlation m′th in-phase intermediate results is performed thereafter sequentially; and, a result of performing integration of outputs from the first through (1×k)′th second multipliers among the n-integral-multiple second multipliers is taken as a correlation first quadrature intermediate value, a result of performing integration of outputs from the first through (2×k)′th second multipliers is taken as a correlation second quadrature intermediate value, and output as correlation m′th quadrature intermediate results is performed thereafter sequentially.

### ADVANTAGEOUS EFFECTS OF INVENTION

According to the present invention, by deciding an amount of displacement of a carrier frequency from a correlation intermediate value distribution characteristic, a code phase, carrier frequency, and carrier frequency phase match can be detected even if a carrier frequency is greatly displaced, and frequency error can be corrected over a wide range.

### BRIEF DESCRIPTION OF DRAWINGS

FIG. 1 is a block diagram showing a configuration of a receiver that performs conventional frequency error detection control;

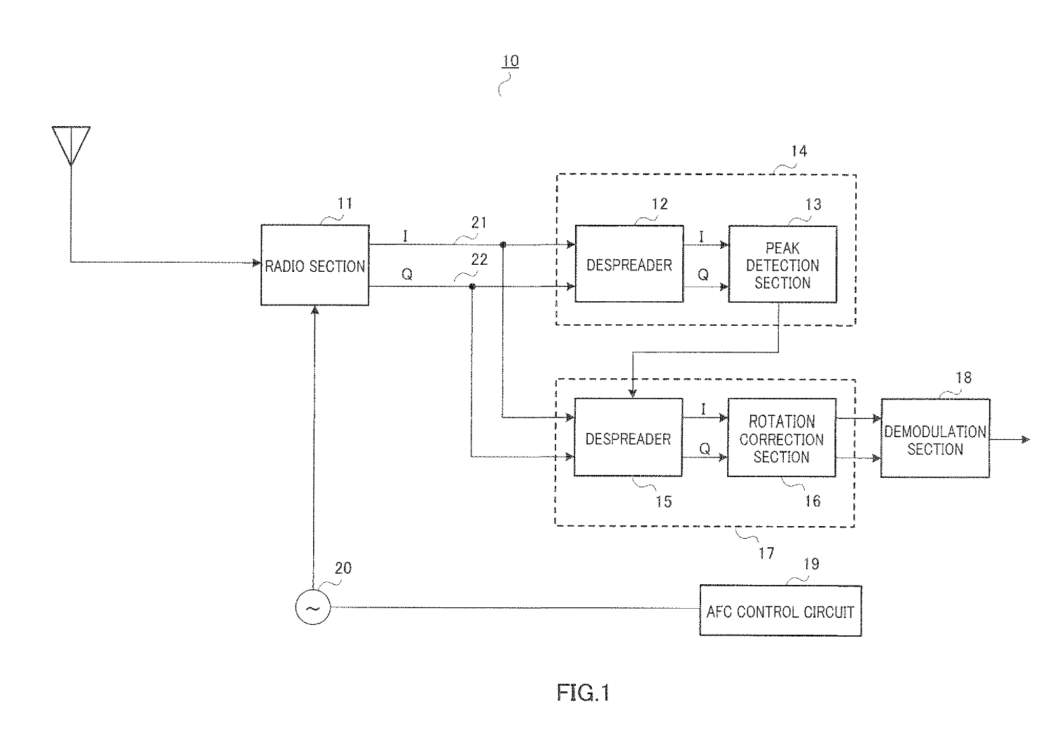

FIG. 2 is a circuit configuration diagram of a conventional receiver;

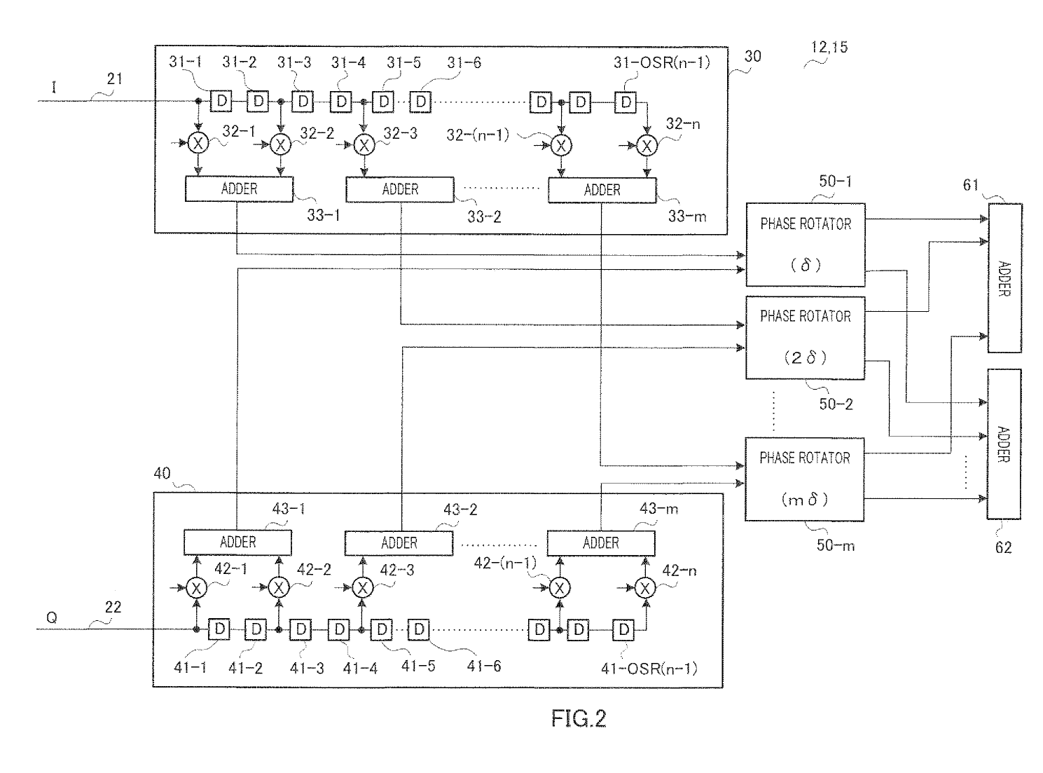

FIG. 3 is a block diagram showing a configuration of a carrier frequency synchronization detection circuit according to an embodiment of the present invention;

FIG. 4 is a circuit diagram of a correlation value calculation section of a carrier frequency synchronization detection circuit according to the above embodiment;

FIG. 5 is a drawing showing a distribution of correlation intermediate values calculated by a correlation value calculation section of a carrier frequency synchronization detection circuit according to the above embodiment;

FIG. 6 is a drawing showing a distribution of correlation intermediate values calculated by a correlation value calculation section of a carrier frequency synchronization detection circuit according to the above embodiment;

FIG. 7 is a drawing showing a distribution of correlation intermediate values calculated by a correlation value calculation section of a carrier frequency synchronization detection circuit according to the above embodiment;

FIG. 8 is a drawing showing a distribution of correlation intermediate values calculated by a correlation value calculation section of a carrier frequency synchronization detection circuit according to the above embodiment;

FIG. 9 is a drawing explaining determination by a correlation intermediate value monitoring section of a distribution of correlation intermediate values calculated by a correlation value calculation section of a carrier frequency synchronization detection circuit according to the above embodiment;

FIG. 10 is a drawing explaining determination by a correlation intermediate value monitoring section of a distribution of correlation intermediate values calculated by a correlation value calculation section of a carrier frequency synchronization detection circuit according to the above embodiment;

FIG. 11 is a drawing explaining determination by a correlation intermediate value monitoring section of a distribution of correlation intermediate values calculated by a correlation value calculation section of a carrier frequency synchronization detection circuit according to the above embodiment;

FIG. 12 is a drawing explaining determination by correlation intermediate value monitoring section of a distribution of correlation intermediate values calculated by a correlation value calculation section of a carrier frequency synchronization detection circuit according to the above embodiment; and

FIG. 13 is a drawing explaining determination by a correlation intermediate value monitoring section of a distribution of correlation intermediate values calculated by a correlation value calculation section of a carrier frequency synchronization detection circuit according to the above embodiment.

### DESCRIPTION OF EMBODIMENTS

Now, an embodiment of the present invention will be described in detail with reference to the accompanying drawings.

### Embodiment

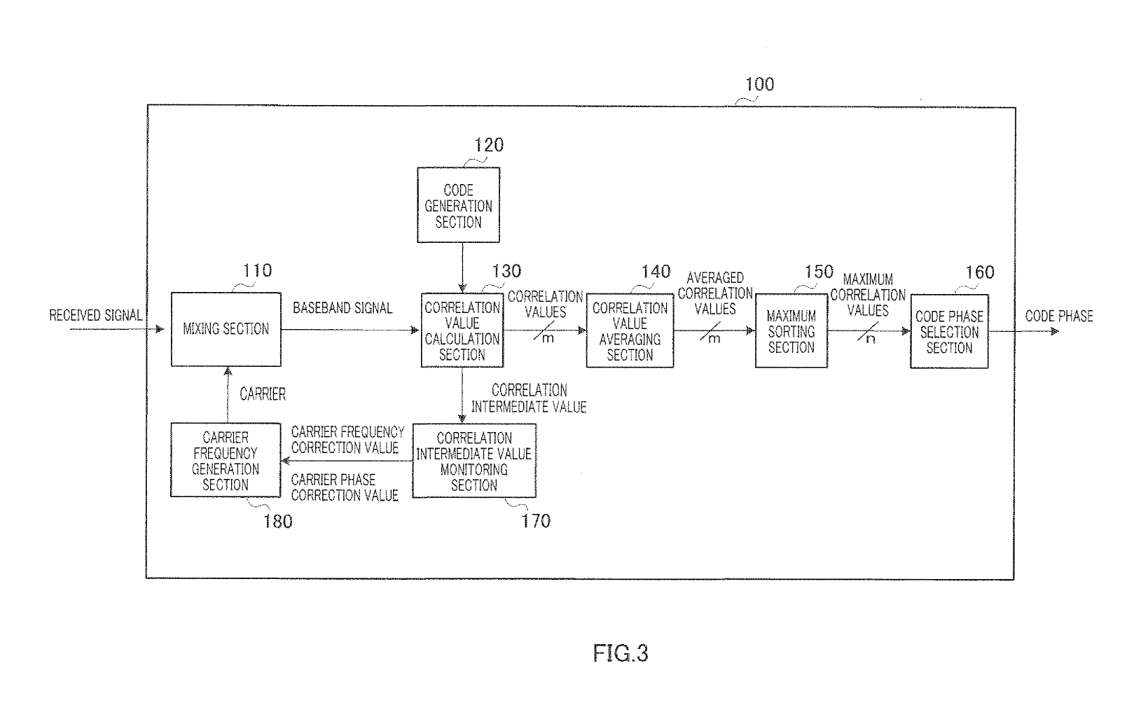

FIG. 3 is a block diagram showing a configuration of a carrier frequency synchronization detection circuit according to one embodiment of the present invention. A carrier frequency synchronization detection circuit of this embodiment can be applied to a portable terminal apparatus provided with a positioning function by means of a GPS system. A portable terminal apparatus may be a mobile terminal such as a mobile phone or PHS (Personal Handy-Phone System) terminal, or may be a portable information terminal such as a portable notebook PC or a PDA (Personal Digital Assistant).

As shown in FIG. 3, carrier frequency synchronization detection circuit 100 comprises mixing section 110, code generation section 120, correlation value calculation section 130, correlation value averaging section 140, maximum sorting section 150, code phase selection section 160, correlation intermediate value monitoring section 170, and carrier frequency generation section 180.

Mixing section 110 removes a carrier frequency component from a received signal.

Code generation section 120 generates a spread code for performing despreading processing in synchronization with a received signal on which spreading processing has been executed. Code generation section 120 generates a spread code sequence identical to a spread code sequence on which spreading processing has been performed on the transmitting side, and outputs this to correlation value calculation section 130.

Correlation value calculation section 130 calculates a correlation value between a received signal from which a carrier frequency component has been removed by mixing section 110 and a spread code generated by code generation section 120 and a correlation intermediate value.

Correlation value averaging section 140 averages correlation values output from correlation value calculation section 130, on a regular basis, over a plurality of periods.

Maximum sorting section 150 selects an average correlation value having a maximum value from among average correlation values, and outputs code phase information for the selected correlation value to code phase selection section 160.

Code phase selection section 160 determines spread code sequence generation timing based on a correlation value selected by maximum sorting section 150.

Correlation intermediate value monitoring section 170 outputs a carrier frequency correction value and carrier phase correction value from a correlation intermediate value output from correlation value calculation section 130. Correlation intermediate value monitoring section 170 determines whether or not a carrier frequency and carrier phase match based on a correlation intermediate value output from correlation value calculation section 130.

Carrier frequency generation section 180 generates a carrier frequency based on the carrier frequency correction value and carrier phase correction value output from correlation intermediate value monitoring section 170, and outputs the generated carrier frequency to mixing section 110.

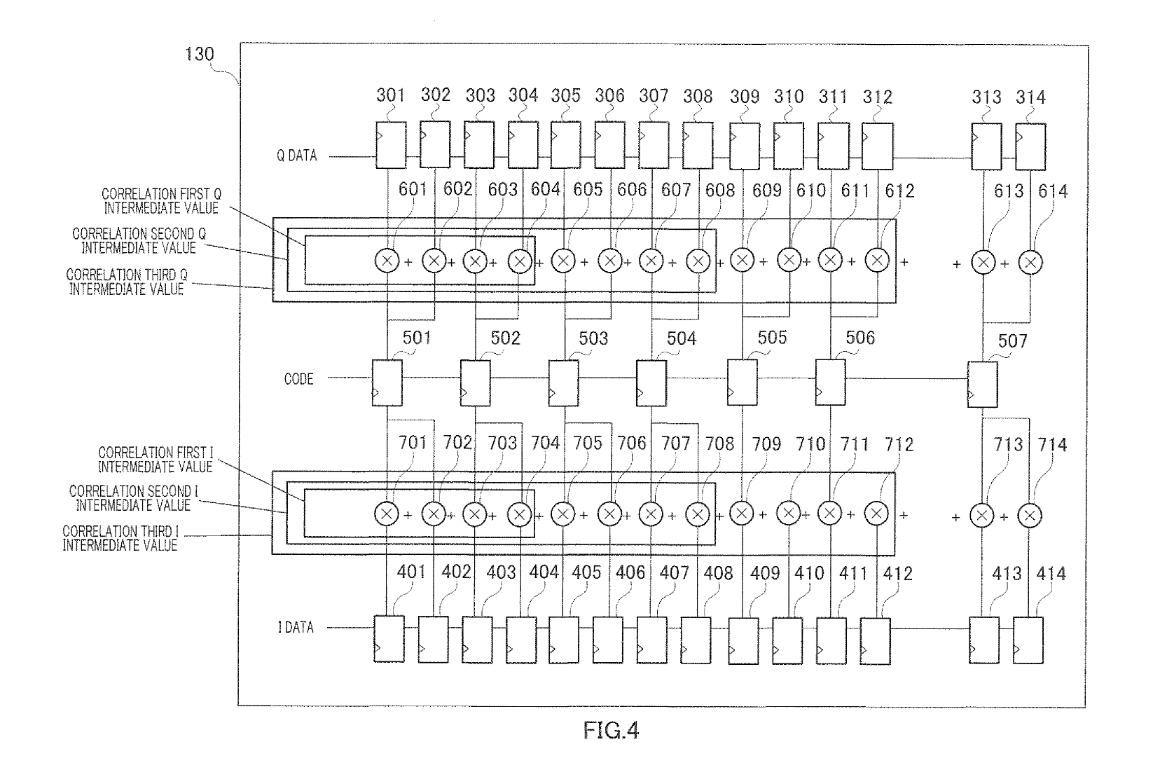

FIG. 4 is a circuit diagram showing the detailed configuration of above correlation value calculation section 130.

As shown in FIG. 4, correlation value calculation section 130 performs correlation value calculation to obtain a correlation of a spread code with a complex baseband signal composed of I component (in-phase component) and Q component (quadrature component) baseband signals spread by a spread code of n chips per symbol.

Correlation value calculation section 130 has n storage elements 501 through 507 that store a spread code, n-integral-multiple first delay elements 401 through 414 that perform sequential shifting by delaying an I component baseband signal by a fixed time interval, and n-integral-multiple first multipliers 701 through 714 that respectively perform multiplication between I component baseband signals sequentially shifted by first delay elements 401 through 414 and storage elements 501 through 507. Correlation value calculation section 130 has n-integral-multiple second delay elements 301 through 314 that perform sequential shifting by delaying a Q component baseband signal by a fixed time interval, and n-integral-multiple second multipliers 601 through 614 that respectively perform multiplication between Q component baseband signals sequentially shifted by second delay elements 301 through 314 and storage elements 501 through 507.

Correlation value calculation section 130 takes a result of performing integration of outputs from the first through (1×k)′th first multipliers among n-integral-multiple first multipliers 701 through 714 as a correlation first I intermediate value, takes a result of performing integration of outputs from the first through (2×k)′th first multipliers as a correlation second I intermediate value, and thereafter sequentially outputs correlation m′th I intermediate results. Also, correlation value calculation section 130 takes a result of performing integration of outputs from the first through (1×k)′th second multipliers among the n-integral-multiple second multipliers as a correlation first Q intermediate value, takes a result of performing integration of outputs from the first through (2×k)′th second multipliers as a correlation second Q intermediate value, and thereafter sequentially outputs correlation m′th Q intermediate results.

The operation of a carrier frequency synchronization detection circuit configured as described above will now be explained.

[Operation of Correlation Value Calculation Section 130]

Correlation value calculation section 130 is a correlator that performs correlation of a spread code with a complex baseband signal composed of I component and Q component baseband signals spread by a spread code of n chips per symbol.

First, a spread code is stored in n storage elements 501 through 507.

In this embodiment, an I component baseband signal is sequentially shifted by being delayed by a ½-chip time interval, and stored in 2n first delay elements 401 through 414.

2n multipliers 701 through 714 respectively perform multiplication between I component baseband signals stored in first delay elements 401 and 402 and spread codes stored in storage elements 501 through 507.

FIG. 4 shows an example in which correlation intermediate values are added for outputs of four multipliers at a time.

A result of adding outputs of multipliers 701 through 704 is taken as a correlation first I intermediate value, a result of adding outputs of multipliers 701 through 708 is taken as a correlation second I intermediate value, a result of adding outputs of multipliers 701 through 712 is taken as a correlation third I intermediate value, and thereafter a correlation intermediate value resulting from adding outputs from multiplier 701 up to a multiplier of a multiple of 4 is output.

Similarly, a result of adding outputs of multipliers 601 through 604 is taken as a correlation first Q intermediate value, a result of adding outputs of multipliers 601 through 608 is taken as a correlation second Q intermediate value, a result of adding outputs of multipliers 601 through 612 is taken as a correlation third Q intermediate value, and thereafter a correlation intermediate value resulting from adding outputs from multiplier 601 up to multiplier of a multiple of 4 is output.

[Operation of Correlation Intermediate Value Monitoring Section 170]

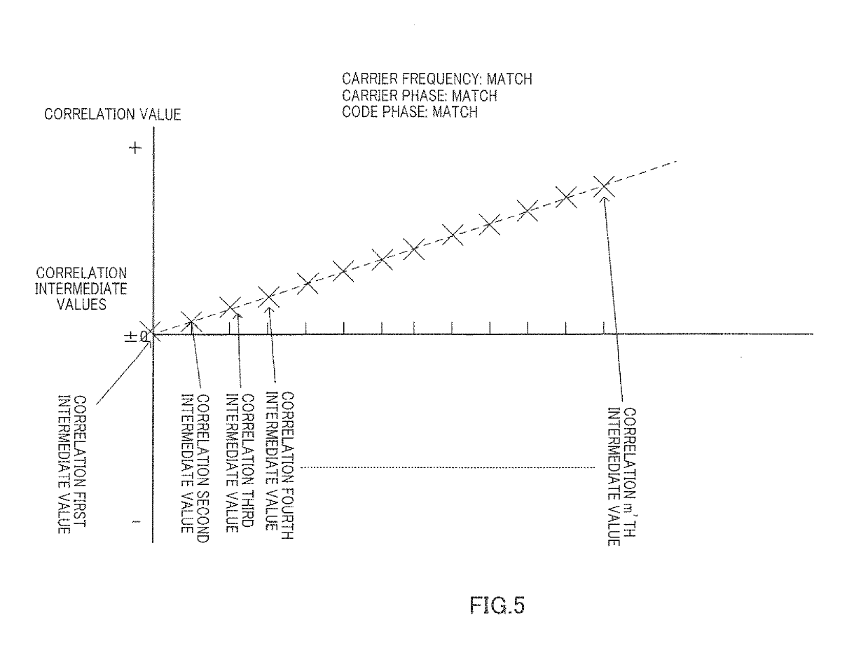

FIG. 5 through FIG. 8 are drawings showing distributions of correlation intermediate values calculated by correlation value calculation section 130. Correlation intermediate value monitoring section 170 monitors the correlation intermediate values shown in FIG. 5 through FIG. 8.

As shown in FIG. 5 through FIG. 8, a correlation intermediate value distribution differs according to carrier frequency, carrier phase, and code phase matching.

As shown in FIG. 5 through FIG. 8, a correlation intermediate value distribution differs according to carrier frequency, carrier phase, and code phase matching.

That is to say, as shown in FIG. 5, when the carrier frequency, carrier phase, and code phase match, the correlation intermediate value distribution increases or decreases linearly.

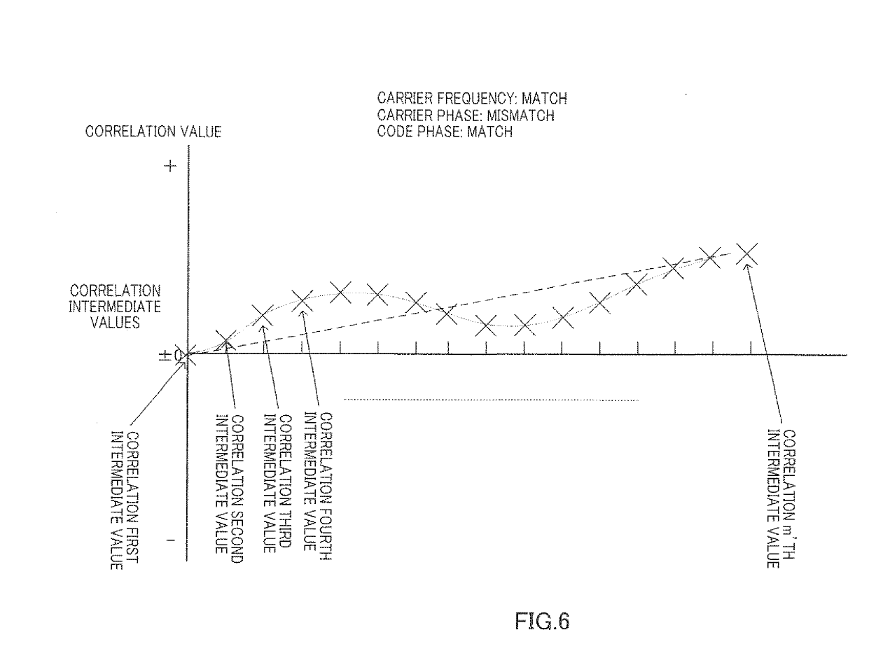

As shown in FIG. 6, when the carrier frequency and code phase match but the carrier phase does not match, correlation intermediate values are distributed in a manner combining a straight line and a sine wave.

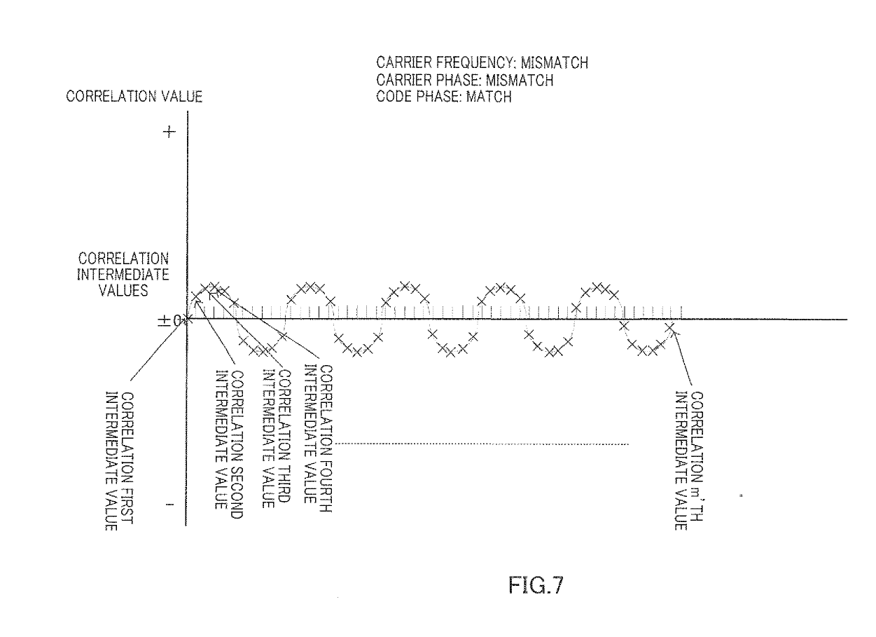

As shown in FIG. 7, when the carrier frequency and carrier phase do not match, but the code phase matches, correlation intermediate values are distributed in a sine wave shape.

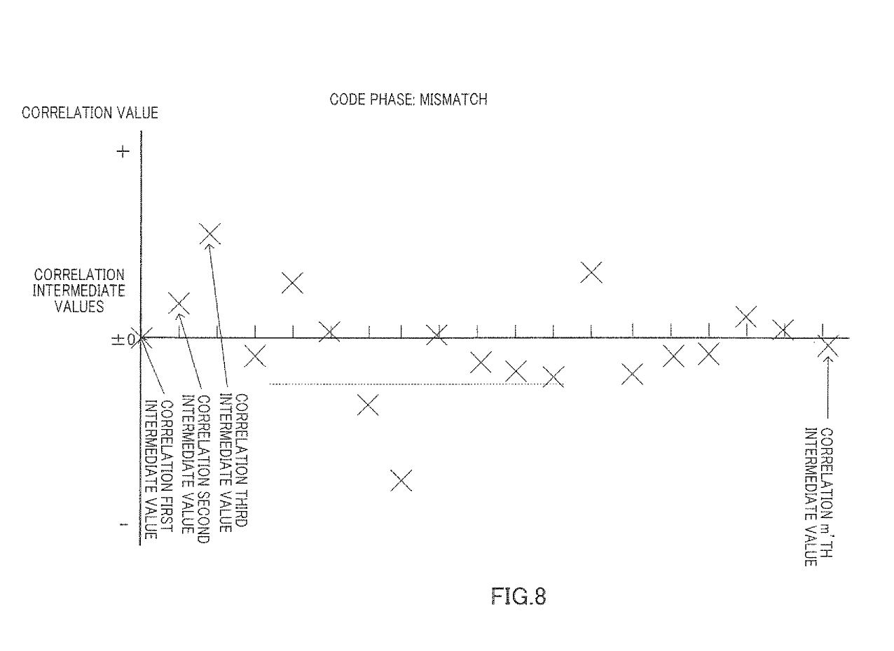

As shown in FIG. 8, if the code phase does not match, correlation intermediate values are distributed in a disorderly fashion.

Focusing on this characteristic, correlation intermediate value monitoring section 170 need only correct a carrier frequency output to mixing section 110 so that the distribution of correlation intermediate values changes from a sine wave shape to a straight line. Specifically, correlation intermediate value monitoring section 170 performs determinations [1] through [4] below.

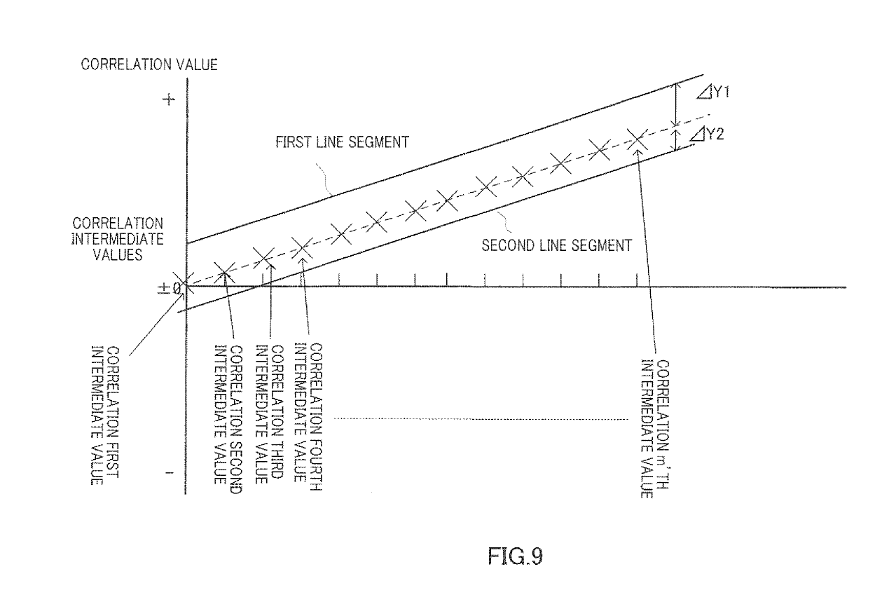

FIG. 9 through FIG. 13 are drawings explaining determination by correlation intermediate value monitoring section 170 in distributions of correlation intermediate values calculated by correlation value calculation section 130.

[1] <<Linearly Increasing or Decreasing Distribution>>

When distribution increases or decreases linearly in a distribution characteristic of intermediate correlation values sequentially indicating values of a correlation first I intermediate result through a correlation m′th I intermediate result or values of a correlation first Q intermediate result through a correlation m′th Q intermediate result, as shown in FIG. 5, it is determined that a frequency component and phase component of a carrier frequency can be removed from a received signal by mixing section 110, and a spread code generated by the code generation section matches.

### Example 1

FIG. 9 shows an example of a method whereby correlation intermediate value monitoring section 170 determines a distribution to be increasing or decreasing linearly.

With an intermediate correlation value distribution characteristic showing the size of intermediate values in the Y-axis direction with a correlation first intermediate value through correlation m′th intermediate value arranged in progressively ascending order from left to right and X-axis direction intervals arranged at equal intervals, as shown in FIG. 9, features are that the correlation m′th intermediate value and correlation first intermediate value are joined by a straight line, and the correlation first intermediate value through correlation m′th intermediate value are distributed within an area enclosed by a first line segment obtained by adding fixed value ΔY1 to the straight line in the Y-axis direction and a second line segment obtained by subtracting fixed value ΔY2 from the straight line in the Y-axis direction.

### Example 2

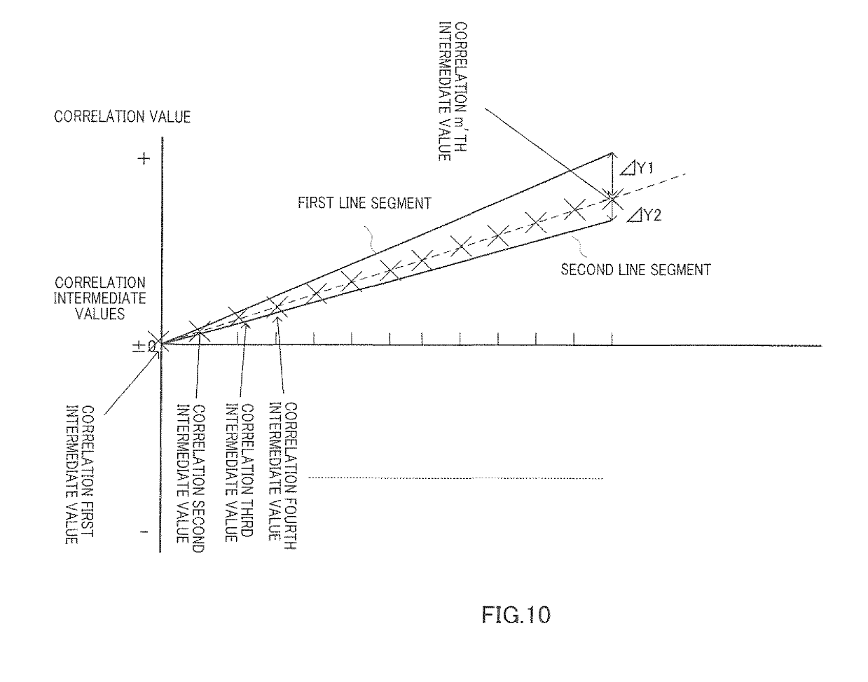

FIG. 10 shows another example of a method whereby correlation intermediate value monitoring section 170 determines a distribution to be increasing or decreasing linearly.

With an intermediate correlation value distribution characteristic showing the size of intermediate values in the Y-axis direction with a correlation first intermediate value through correlation m′th intermediate value arranged in progressively ascending order from left to right and X-axis direction intervals arranged at equal intervals, as shown in FIG. 10, a feature is that the correlation first intermediate value through correlation m′th intermediate value are distributed within an area defined by joining the correlation first intermediate value, a point obtained by adding fixed value ΔY1 to the correlation m′th intermediate value in the Y-axis direction, and a point obtained by subtracting fixed value ΔY2 from the correlation m′th intermediate value in the Y-axis direction, by a straight line.

For above ΔY1 and ΔY2, if a received signal with no signal component and only a noise component is received, a value that is a 3 sigma value to 4 sigma value of a value statistically processed by multiple measurements of a correlation m′th intermediate value is used.

[2] <<Distribution in a Manner Combining Straight Line and Sine Wave>>

With an intermediate correlation value distribution characteristic sequentially showing values of a correlation first I intermediate result through a correlation m′th I intermediate result or values of a correlation first Q intermediate result through a correlation m′th Q intermediate result, when correlation intermediate values are distributed in a manner combining a straight line and a sine wave, as shown in FIG. 6, it is determined that a carrier frequency component of a received signal on which spreading processing has been performed matches, but a carrier frequency phase is displaced.

### Example 3

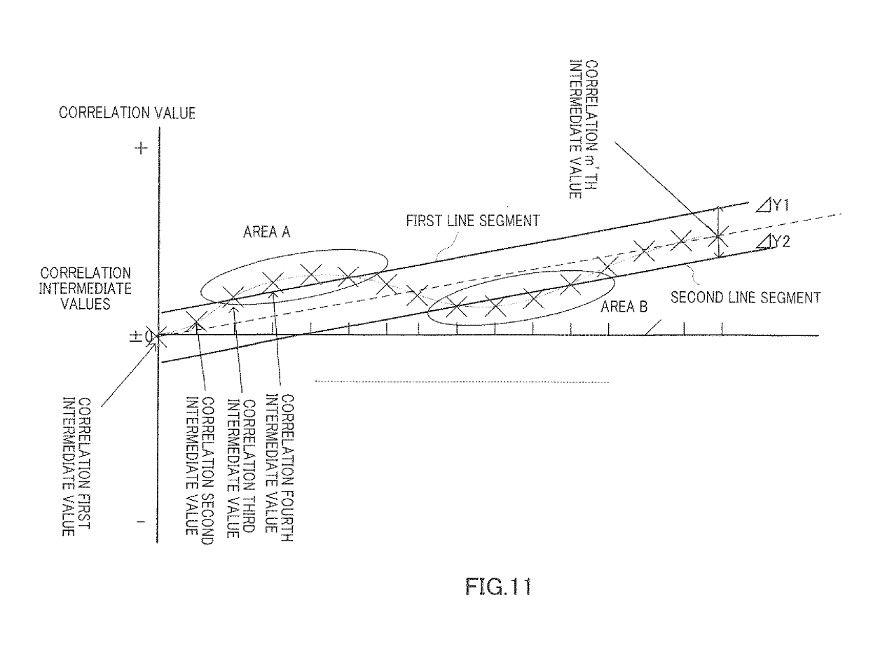

FIG. 11 shows an example of a method whereby correlation intermediate value monitoring section 170 determines that correlation intermediate vales are distributed in a fashion combining a straight line and a sine wave.

With an intermediate correlation value distribution characteristic showing the size of intermediate values in the Y-axis direction with values of a correlation first intermediate result through correlation m′th intermediate result arranged in progressively ascending order from left to right and X-axis direction intervals arranged at equal intervals, as shown in FIG. 11, features are that the correlation m′th intermediate value and correlation first intermediate value are joined by a straight line, and the number of places where the distribution of the correlation first intermediate value through correlation m′th intermediate value exceeds a first line segment, and the number of places where the distribution of the correlation first intermediate value through correlation m′th intermediate value falls below a second line segment, from within an area enclosed by the first line segment obtained by adding fixed value ΔY1 to the straight line in the Y-axis direction and a second line segment obtained by subtracting fixed value ΔY2 from the straight line in the Y-axis direction, are less than or equal to 1.

In FIG. 11, it is shown that there is one place, area A, where the distribution exceeds the first line segment, and there is one place, area B, where the distribution falls below the second line segment.

For above ΔY1 and ΔY2, if a received signal with no signal component and only a noise component is received, a value that is a 3 sigma value to 4 sigma value of a value statistically processed by multiple measurements of a correlation m′th intermediate value is used.

[3] <<Sine Wave Distribution>>

In the case of sine wave distribution in a distribution characteristic of intermediate correlation values sequentially indicating values of a correlation first I intermediate result through a correlation m′th I intermediate result or values of a correlation first Q intermediate result through a correlation m′th Q intermediate result, as shown in FIG. 7, it is determined that a carrier frequency component of a received signal on which spreading processing has been performed is displaced, but a spread code matches.

### Example 4

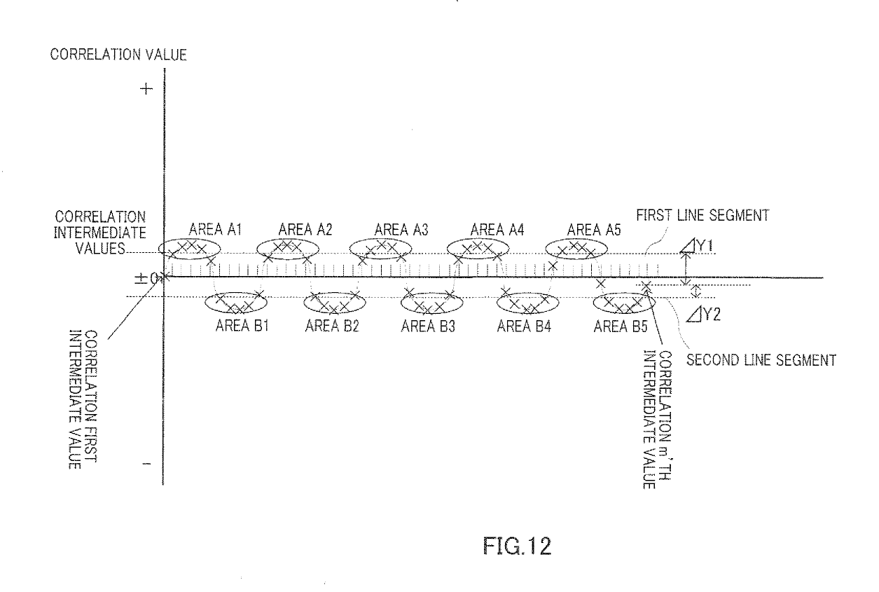

FIG. 12 shows an example of a method whereby correlation intermediate value monitoring section 170 determines distribution to have a sine wave shape.

With an intermediate correlation value distribution characteristic showing the size of intermediate values in the Y-axis direction with values of a correlation first intermediate result through correlation m′th intermediate result arranged in progressively ascending order from left to right and X-axis direction intervals arranged at equal intervals, as shown in FIG. 12, features are that the correlation m′th intermediate value and correlation first intermediate value are joined by a straight line, and, with respect to a first line segment obtained by adding fixed value ΔY1 to the straight line in the Y-axis direction and a second line segment obtained by subtracting fixed value ΔY2 from the straight line in the Y-axis direction, a first number of places where the distribution of the correlation first intermediate value through correlation m′th intermediate value exceeds the first line segment, and a second number of places where the distribution of the correlation first intermediate value through correlation m′th intermediate value falls below the second line segment, match for a number greater than 1, or have numeric values differing by only 1 for a number greater than 1.

In FIG. 12, it is shown that the distribution exceeds the first line segment in five places, area A1 and area A2 through area A5, and the distribution falls below the second line segment in five places, area B1 and area B2 through area B5.

### Example 5

Also, with an intermediate correlation value distribution characteristic showing the size of intermediate values in the Y-axis direction with values of a correlation first intermediate result through correlation m′th intermediate result arranged in progressively ascending order from left to right and X-axis direction intervals arranged at equal intervals, as shown in FIG. 12, features are that the correlation m′th intermediate value and correlation first intermediate value are joined by a straight line, and, with respect to a first line segment obtained by adding fixed value ΔY1 to the straight line in the Y-axis direction and a second line segment obtained by subtracting fixed value ΔY2 from the straight line in the Y-axis direction, a place where the distribution exceeds the first line segment and a place where the distribution falls below the second line segment, appear alternately.

In above (Example 5), it is shown that areas where the distribution exceeds the first line segment and areas where the distribution falls below the second line segment, appear alternately as area A1, area B1, area A2, area B2, . . . area A5, area B5.

For above ΔY1 and ΔY2, if a received signal with no signal component and only a noise component is received, a value that is a 3 sigma value to 4 sigma value of a value statistically processed by multiple measurements of a correlation m′th intermediate value is used.

[4] <<Disorderly Distribution>>

In the case of disorderly distribution in a distribution characteristic of intermediate correlation values sequentially indicating values of a correlation first I intermediate result through a correlation m′th I intermediate result or values of a correlation first Q intermediate result through a correlation m′th Q intermediate result, as shown in FIG. 8, it is determined that a spread code does not match.

### Example 6

An example of a method of determining disorderly distribution is a case that does not correspond to any of the determination methods described in (Example 1) through (Example 5) above.

### Example 7

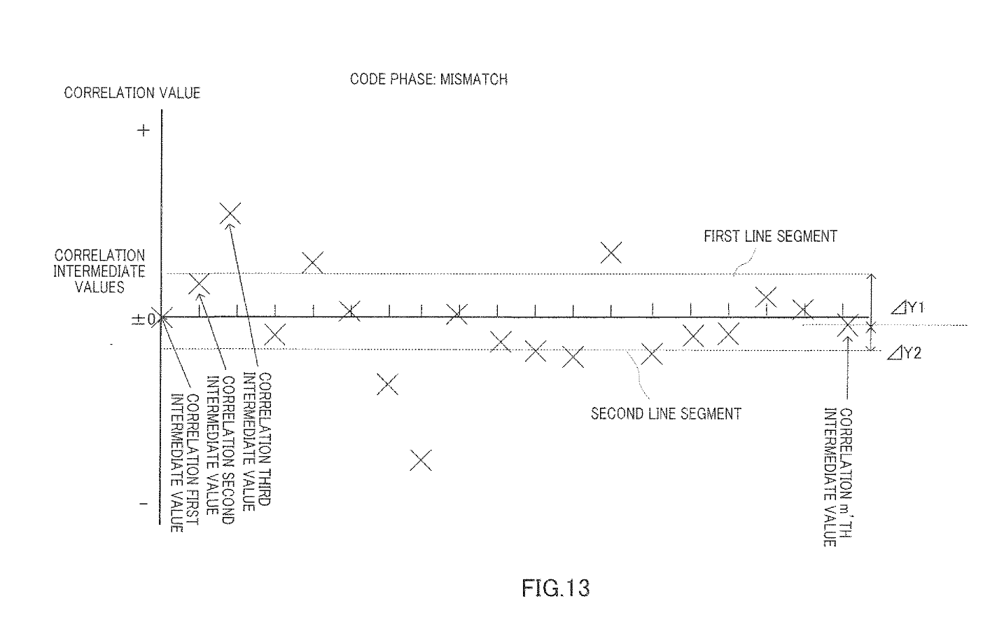

FIG. 13 shows another example of a method whereby correlation intermediate value monitoring section 170 determines distribution to be disorderly.

With an intermediate correlation value distribution characteristic showing the size of intermediate values in the Y-axis direction with values of a correlation first intermediate result through correlation m′th intermediate result arranged in progressively ascending order from left to right and X-axis direction intervals arranged at equal intervals, as shown in FIG. 13, features are that the correlation m′th intermediate value and correlation first intermediate value are joined by a straight line, and, with respect to a first line segment obtained by adding fixed value ΔY1 to the straight lien in the Y-axis direction and a second line segment obtained by subtracting fixed value ΔY2 from the straight line in the Y-axis direction, a place where the distribution of the correlation first intermediate value through correlation m′th intermediate value exceeds the first line segment and a place where the distribution of the correlation first intermediate value through correlation m′th intermediate value falls below the second line segment, do not appear alternately.

This concludes a description of determination by correlation intermediate value monitoring section 170 of a distribution of correlation intermediate values calculated by correlation value calculation section 130.

Next, correlation intermediate value monitoring section 170 corrects a carrier frequency or carrier phase so that the distribution of correlation intermediate value changes from a sine wave shape to an increasing or decreasing straight line, based on monitoring results.

For example, if the intermediate correlation value distribution characteristic shown in FIG. 7 has been monitored, the carrier phase does not match. Consequently, carrier frequency generation section 180 is directed to perform correction to displace the carrier phase. Alternatively, correlation intermediate value monitoring section 170 calculates a carrier frequency or carrier phase correction amount, and outputs this to carrier frequency generation section 180. Based on a carrier frequency or carrier phase correction amount output from correlation intermediate value monitoring section 170, carrier frequency generation section 180 generates a carrier frequency that eliminates the carrier frequency displacement amount, and outputs the generated carrier frequency to mixing section 110.

As described in detail above, carrier frequency synchronization detection circuit 100 has mixing section 110, code generation section 120, correlation value calculation section 130, correlation value averaging section 140, maximum sorting section 150, code phase selection section 160, correlation intermediate value monitoring section 170, and carrier frequency generation section 180. Correlation value calculation section 130 has n storage elements 501 through 507 that store a spread code, n-integral-multiple first delay elements 401 through 414 that perform sequential shifting by delaying an I component baseband signal by a fixed time interval, and n-integral-multiple first multipliers 701 through 714 that respectively perform multiplication between I component baseband signals sequentially shifted by first delay elements 401 through 414 and storage elements 501 through 507. Also, correlation value calculation section 130 has n-integral-multiple second delay elements 301 through 314 that perform sequential shifting by delaying a Q component baseband signal by a fixed time interval, and n-integral-multiple second multipliers 601 through 614 that respectively perform multiplication between Q component baseband signals sequentially shifted by second delay elements 301 through 314 and storage elements 501 through 507.

Correlation value calculation section 130 takes a result of performing integration of outputs from the first through (1×k)′th first or second multipliers among the n-integral-multiple first or second multipliers 701 through 714 as a correlation first intermediate value, takes a result of performing integration of outputs from the first through (2×k)′th first or second multipliers as a correlation second intermediate value, and thereafter sequentially outputs correlation m′th intermediate results. Correlation intermediate value monitoring section 170 decides a carrier frequency displacement amount from a correlation value calculation section 130 correlation intermediate value distribution characteristic, and outputs a carrier frequency correction value and a carrier phase correction value.

By this means, a code phase, carrier frequency, and carrier frequency phase match can be detected even if a carrier frequency is greatly displaced due to a Doppler effect when a spread spectrum signal transmitted from a satellite is received by a GPS receiver, and frequency error can be corrected over a wide range.

The above description presents an example of a preferred embodiment of the present invention, but the scope of the present invention is not limited to this.

In the above embodiment, the terms “correlation calculator” and “carrier frequency synchronization detection circuit” have been used, but this is simply for convenience of description, and terms such as “positioning receiving apparatus” and “frequency error measuring method” may, of course, also be used.

The type, number, connection method, and so forth of circuit sections configuring an above-described portable radio are not limited to those in the above embodiment,

### INDUSTRIAL APPLICABILITY

A carrier frequency synchronization detection circuit and correlation calculator according to the present invention are suitable for use in a carrier frequency synchronization detection circuit and positioning system that acquire a signal sent from a GPS or suchlike positioning satellite. They are also useful for a mobile phone, PHS terminal, or suchlike portable terminal apparatus equipped with a carrier frequency synchronization detection circuit and positioning method. Furthermore, they can be widely applied, not only to a GPS positioning system, but also to positioning systems in which a plurality of satellite signals that have undergone spread spectrum processing by means of a synchronized plurality of modulation codes, such as the Galileo system, the Russian GLONASS, United States' WAAS, Japanese MSAS, and European EGNOS.

### REFERENCE SIGNS LIST

100 Carrier frequency synchronization detection circuit
110 Mixing section
120 Code generation section
130 Correlation value calculation section
140 Correlation value averaging section
150 Maximum sorting section
160 Code phase selection section
170 Correlation intermediate value monitoring section
180 Carrier frequency generation section
501 through 507 Storage elements
301 through 314 Second delay elements
401 through 414 First delay elements
601 through 614 Second multipliers
701 through 714 First multipliers

1. A carrier frequency synchronization detection circuit comprising:
a code generation section that generates a spread code for performing despreading processing in synchronization with a received signal on which spreading processing has been executed;
a mixing section that removes a carrier frequency component from a received signal;
a correlation value calculation section that calculates a correlation value between a received signal from which a carrier frequency component has been removed by said mixing section and a spread code generated by said code generation section and a plurality of correlation intermediate values of a predetermined correlation length;
a correlation value averaging section that averages correlation values output from said correlation value calculation section, on a regular basis, over a plurality of periods;
a maximum sorting section that selects a maximum correlation value from among averaged correlation values;
a code phase selection section that determines spread code sequence generation timing based on a correlation value selected by said maximum sorting section;
a correlation intermediate value monitoring section that outputs a carrier frequency correction value and carrier phase correction value from a correlation intermediate value output from said correlation value calculation section; and
a carrier frequency generation section that outputs a carrier frequency to said mixing section based on the carrier frequency correction value and carrier phase correction value output from said correlation intermediate value monitoring section.

2. The carrier frequency synchronization detection circuit according to claim 1, comprising:
n (where n is an arbitrary natural number of 2 or above) storage elements that store a spread code;
n-integral-multiple first delay elements that perform sequential shifting by delaying an in-phase component baseband signal by a fixed time interval, and n-integral-multiple first multipliers that respectively perform multiplication between in-phase component baseband signals sequentially shifted by said first delay elements and said storage elements; and
n-integral-multiple second delay elements that perform sequential shifting by delaying a quadrature component baseband signal by a fixed time interval, and n-integral-multiple second multipliers that respectively perform multiplication between quadrature component baseband signals sequentially shifted by said second delay elements and said storage elements, wherein:
a result of performing integration of outputs from first through (1×k)′th (where k is an arbitrary natural number of 2 or above) first multipliers among n-integral-multiple said first multipliers is taken as a correlation first in-phase intermediate value, a result of performing integration of outputs from first through (2×k)′th first multipliers is taken as a correlation second in-phase intermediate value, and output as correlation m′th in-phase intermediate results is performed thereafter sequentially; and
a result of performing integration of outputs from first through (1×k)′th second multipliers among n-integral-multiple said second multipliers is taken as a correlation first quadrature intermediate value, a result of performing integration of outputs from first through (2×k)′th second multipliers is taken as a correlation second quadrature intermediate value, and output as correlation m′th quadrature intermediate results is performed thereafter sequentially.

3. The carrier frequency synchronization detection circuit according to claim 1, wherein said correlation intermediate value monitoring section, with an intermediate correlation value distribution characteristic showing a size of said intermediate values in a Y-axis direction with a correlation first intermediate value through correlation m′th intermediate value arranged in progressively ascending order from left to right and X-axis direction intervals arranged at equal intervals, when a correlation m′th intermediate value and correlation first intermediate value are joined by a straight line, and a correlation first intermediate value through correlation myth intermediate value are distributed within an area enclosed by a line segment obtained by adding fixed value ΔY1 to said straight line in the Y-axis direction and a line segment obtained by subtracting fixed value ΔY2 from said straight line in the Y-axis direction, holds a carrier frequency correction value and carrier phase correction value output from said correlation intermediate value monitoring section, and holds a phase of a spread code output from said code generation section.

4. The carrier frequency synchronization detection circuit according to claim 1, wherein said correlation intermediate value monitoring section, with an intermediate correlation value distribution characteristic showing a size of said intermediate values in a Y-axis direction with a correlation first intermediate value through correlation m′th intermediate value arranged in progressively ascending order from left to right and X-axis direction intervals arranged at equal intervals, when a correlation first intermediate value through correlation m′th intermediate value are distributed within an area defined by joining a correlation first intermediate value, a point obtained by adding fixed value ΔY1 to the correlation m′th intermediate value in the Y-axis direction, and a point obtained by subtracting fixed value ΔY2 from the correlation m′th intermediate value in the Y-axis direction, holds a carrier frequency correction value and carrier phase correction value output from said correlation intermediate value monitoring section, and holds a phase of a spread code output from said code generation section.

5. The carrier frequency synchronization detection circuit according to claim 1, wherein said correlation intermediate value monitoring section, with an intermediate correlation value distribution characteristic showing a size of said intermediate values in a Y-axis direction with a correlation first intermediate value through correlation m′th intermediate value arranged in progressively ascending order from left to right and X-axis direction intervals arranged at equal intervals, when a correlation m′th intermediate value and correlation first intermediate value are joined by a straight line, and, with respect to a first line segment obtained by adding fixed value ΔY1 to said straight line in the Y-axis direction and a second line segment obtained by subtracting fixed value ΔY2 from said straight line in the Y-axis direction, a first number of places where a distribution of a correlation first intermediate value through correlation m′th intermediate value exceeds said first line segment, and a second number of places where the distribution falls below said second line segment, are both less than or equal to 1, holds a carrier frequency correction value output from said correlation intermediate value monitoring section, changes a carrier phase correction value output from said correlation intermediate value monitoring section, and holds a phase of a spread code output from said code generation section.

6. The carrier frequency synchronization detection circuit according to claim 1, wherein said correlation intermediate value monitoring section, with an intermediate correlation value distribution characteristic showing a size of said intermediate values in a Y-axis direction with a correlation first intermediate value through correlation m′th intermediate value arranged in progressively ascending order from left to right and X-axis direction intervals arranged at equal intervals, when a correlation m′th intermediate value and correlation first intermediate value are joined by a straight line, and, with respect to a first line segment obtained by adding fixed value ΔY1 to said straight line in the Y-axis direction and a second line segment obtained by subtracting fixed value ΔY2 from said straight line in the Y-axis direction, a first number of places where a distribution of a correlation first intermediate value through correlation m′th intermediate value exceeds said first line segment, and a second number of places where the distribution falls below said second line segment, match for a number greater than 1, or both have a difference between said first number and said second number of 1 for a number greater than 1, holds a carrier frequency correction value output from said correlation intermediate value monitoring section, changes a carrier phase correction value output from said correlation intermediate value monitoring section, and holds a phase of a spread code output from said code generation section.

7. The carrier frequency synchronization detection circuit according to claim 1, wherein said correlation intermediate value monitoring section, with an intermediate correlation value distribution characteristic showing a size of said intermediate values in a Y-axis direction with a correlation first intermediate value through correlation m′th intermediate value arranged in progressively ascending order from left to right and X-axis direction intervals arranged at equal intervals, when a correlation m′th intermediate value and correlation first intermediate value are joined by a straight line, and, with respect to a first line segment obtained by adding fixed value ΔY1 to said straight line in the Y-axis direction and a second line segment obtained by subtracting fixed value ΔY2 from said straight lien in the Y-axis direction, a place where a distribution of a correlation first intermediate value through correlation m′th intermediate value exceeds said first line segment and a place where the distribution falls below said second line segment appear alternately, changes a carrier frequency correction value output from said correlation intermediate value monitoring section, and holds a phase of a spread code output from said code generation section.

8. The carrier frequency synchronization detection circuit according to claim 1, wherein said correlation intermediate value monitoring section, with an intermediate correlation value distribution characteristic showing a size of said intermediate values in a Y-axis direction with a correlation first intermediate value through correlation m′th intermediate value arranged in progressively ascending order from left to right and X-axis direction intervals arranged at equal intervals, when a correlation m′th intermediate value and correlation first intermediate value are joined by a straight line, and, with respect to a first line segment obtained by adding fixed value ΔY1 to said straight line in the Y-axis direction and a second line segment obtained by subtracting fixed value ΔY2 from said straight line in the Y-axis direction, a place where a distribution of a correlation first intermediate value through correlation m′th intermediate value exceeds said first line segment and a place where the distribution falls below said second line segment do not appear alternately, changes a phase of a spread code output from said code generation section.

9. A correlation calculator for performing correlation of a spread code with a complex baseband signal composed of in-phase component and quadrature component baseband signals spread by a spread code of n chips (where n is an arbitrary natural number of 2 or above) per symbol, the correlation calculator comprising:
n storage elements that store a spread code;
n-integral-multiple first delay elements that perform sequential shifting by delaying an in-phase component baseband signal by a fixed time interval, and n-integral-multiple first multipliers that respectively perform multiplication between in-phase component baseband signals sequentially shifted by first delay elements and said storage elements; and
n-integral-multiple second delay elements that perform sequential shifting by delaying a quadrature component baseband signal by a fixed time interval, and n-integral-multiple second multipliers that respectively perform multiplication between quadrature component baseband signals sequentially shifted by second delay elements and said storage elements, wherein:
a result of performing integration of outputs from first through (1×k)′th first multipliers among n-integral-multiple first multipliers is taken as a correlation first in-phase intermediate value, a result of performing integration of outputs from first through (2×k)′th first multipliers is taken as a correlation second in-phase intermediate value, and output as correlation m′th in-phase intermediate results is performed thereafter sequentially; and
a result of performing integration of outputs from first through (1×k)′th second multipliers among n-integral-multiple second multipliers is taken as a correlation first quadrature intermediate value, a result of performing integration of outputs from first through (2×k)′th second multipliers is taken as a correlation second quadrature intermediate value, and output as correlation m′th quadrature intermediate results is performed thereafter sequentially.
